(19) United States
(12) Patent Application Publication
(10) Pub. No.: US 2016/0360725 A1
(43) Pub. Date: Dec. 15, 2016

(54) LIFTING-TYPE PET FEEDING VESSEL

(71) Applicant: Jiangsu Zhongheng Pet Articles Joint-Stock Co., Ltd., Jiangsu (CN)

(72) Inventor: Qiu Bin, Jiangsu (CN)

(73) Assignee: Jiangsu Zhongheng Pet Articles Joint-Stock Co., Ltd., Jiangsu (CN)

(21) Appl. No.: 15/170,925

(22) Filed: Jun. 1, 2016

(30) Foreign Application Priority Data
Jun. 1, 2015 (CN) 201520369499.3

(51) Int. Cl. A01K 5/01

(52) U.S. Cl. CPC A01K 5/0114

(57) ABSTRACT

A lifting-type pet feeding vessel includes a hollow cylinder, wherein a lifting tray is provided inside the hollow cylinder, wherein an outer wall of the hollow cylinder is provided with a longitudinal clamping groove, wherein the longitudinal clamping groove is provided with a plurality of clamping positions; and a lifting sliding pole that is configured to slide and fit with the longitudinal clamping groove, wherein clamping hooks on the lifting sliding pole are configured to clamp and fix in different clamping positions to drive the lifting tray up and down to regulate a height of the lifting tray, thereby regulating a height of the pet feeding vessel on the lifting tray.

### CROSS-REFERENCE TO RELATED APPLICATIONS

This Application claims the priority of Chinese Patent Application No. 201520369499.3, filed on Jun. 1, 2015, the disclosure of which is incorporated by reference in its entirety.

### TECHNICAL FIELD

The invention relates to a pet feeding vessel, and more particularly, to a lifting-type pet feeding vessel, which belongs to the technical field of pet supplies.

### BACKGROUND ART

The existing pet feeding vessels are in a simple bowl shape usually, which are lower when being placed on the ground. For a tall pet dog, its head needs to be lowered to a great extent, which is inconvenient for the pet dog to intake food, and is adverse to the health of the pet.

### SUMMARY OF THE INVENTION

An object of the invention is to provide a pet feeding vessel, which can regulate the heights of the feeding vessel according to the heights of the pets, thus regulating the heights of the pet feeding vessel to the most appropriate heights according to different pets.

An embodiment of the present invention adopts a technical solution as follows:

A lifting-type pet feeding vessel includes a hollow cylinder, wherein the inside of the hollow cylinder is fixedly provided with a lifting tray 2. The outer wall of the hollow cylinder is provided with a longitudinal clamping groove 3, and the longitudinal clamping groove 3 is provided with a plurality of clamping positions 3a. A lifting sliding pole 4 is employed to be in slide fit with the longitudinal clamping groove 3, and clamping hooks 4b on the lifting sliding pole 4 are configured to clamp and fix in different clamping positions 3a to drive the lifting tray 2 upwards or downwards to regulate the heights, thereby regulating the heights of the pet feeding vessel on the lifting tray 2.

By regulating different positions of the lifting sliding pole 4 clamped in the longitudinal clamping groove 3, the heights of the hollow cylinder and the lifting tray 2 can be regulated, which in turn regulates the heights of the pet feeding vessel on the lifting tray 2, thereby adapting the device to the food intakes of pets with different sizes.

In a further embodiment, the bottom of the lifting sliding pole 4 is provided with a supporting lug 4a.

In a further embodiment, the periphery of the hollow cylinder is provided with a plurality of symmetrical holding positions 1.

In a further embodiment, both the quantity (number) of the lifting sliding poles 4 and the quantity (number) of the longitudinal clamping grooves 3 are four, which are evenly distributed at the periphery of the hollow cylinder.

The present invention has one or more of the following beneficial effects.
1) Capable of adapting to pets with different heights, and easily selecting an optional heights for different pets during food intake;
2) Simple in structure, and well conceived; and
3) Convenient for taking, using and regulating, and having prospects for broad popularization and applications.

### BRIEF DESCRIPTION OF THE DRAWINGS

FIG. 1 shows a top view of a lifting-type pet feeding vessel according to one embodiment of the invention.

FIG. 2 shows a partial schematic view of the front side of a lifting-type pet feeding vessel according to one embodiment of the invention.

FIG. 3 shows a schematic view of the front side of a lifting sliding pole.

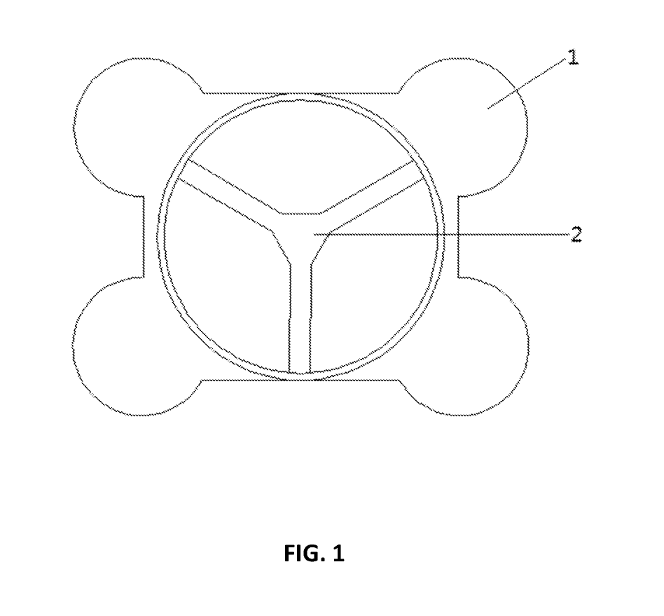

In the FIGS. 1 refers to holding position, 2 refers to lifting tray, 3 refers to longitudinal clamping groove, 4 refers to lifting sliding pole, 3a refers to clamping position, 4a refers to supporting lug, and 4b refers to clamping hook.

### DETAILED DESCRIPTION

Embodiments of the invention will be further described in details hereinafter with reference to the drawings and specific examples. One skilled in the art would appreciate that these examples are for illustration only and are not meant to limit the scope of the invention.

Referring to FIG. 1 to FIG. 3, a lifting-type pet feeding vessel includes a hollow cylinder, wherein the inside of the hollow cylinder is fixedly provided with a lifting tray 2, the outer wall of the hollow cylinder is provided with a longitudinal clamping groove 3, and the longitudinal clamping groove 3 is provided with a plurality of clamping positions 3a. A lifting sliding pole 4 is employed to be in slide fit with the longitudinal clamping groove 3, and clamping hooks 4b on the lifting sliding pole 4 are clamped and fixed in different clamping positions 3a to drive the lifting tray 2 upwards or downwards to regulate the heights, thereby regulating the heights of the pet feeding vessel on the lifting tray 2.

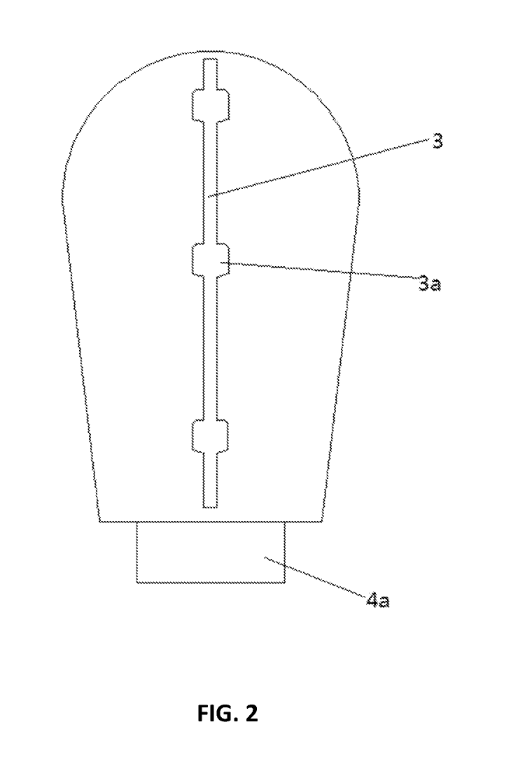

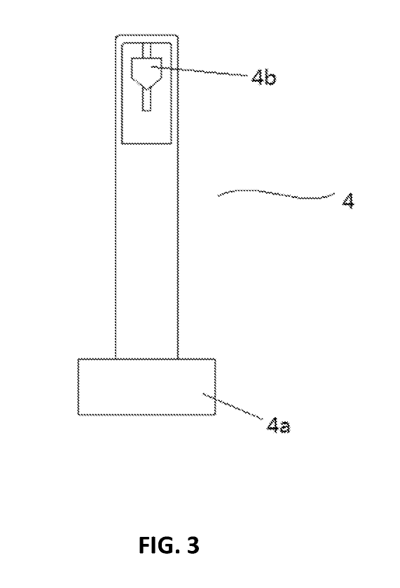

Referring to FIG. 2 to FIG. 3, the bottom of the lifting sliding pole 4 is provided with a supporting lug 4a.

Referring to FIG. 1, the periphery of the hollow cylinder is provided with a plurality of symmetrical holding positions 1.

Referring to FIGS. 1 and 2, in this example, both the quantity of the lifting sliding poles 4 and the quantity of the longitudinal clamping grooves 3 are four, which are evenly distributed at the periphery of the hollow cylinder.

By regulating different positions of the lifting sliding pole 4 clamped in the longitudinal clamping groove 3, the heights of the hollow cylinder and the lifting tray 2 can be regulated, thereby regulating the height of the pet feeding vessel on the lifting tray 2 as well. Thus, the height of the pet feeding vessel can adapt to the food intake of pets with different sizes.

The embodiments of the invention are capable of adapting to pets with different heights, and can provide optional heights for different pets during food intakes. The embodiments of the invention are simple in structure, well conceived; and are convenient for carrying, using and regulating. The embodiments of the invention have potential for broad adoption and applications.

What is claimed is:

1. A lifting-type pet feeding vessel, comprising:
a hollow cylinder, wherein a lifting tray is provided inside the hollow cylinder, wherein an outer wall of the hollow cylinder is provided with a longitudinal clamping groove, wherein the longitudinal clamping groove is provided with a plurality of clamping positions; and
a lifting sliding pole that is configured to slide and fit with the longitudinal clamping groove, wherein clamping hooks on the lifting sliding pole are configured to clamp and fix in different clamping positions to drive the lifting tray up and down to regulate a height of the lifting tray, thereby regulating a height of the pet feeding vessel on the lifting tray.

2. The lifting-type pet feeding vessel according to claim 1, wherein a bottom of the lifting sliding pole is provided with a supporting lug.

3. The lifting-type pet feeding vessel according to claim 1, wherein the periphery of the hollow cylinder is provided with a plurality of symmetrical holding positions.

4. The lifting-type pet feeding vessel according to claim 1, wherein the number of the lifting sliding poles and the number of the longitudinal clamping grooves (3) are both four, which are evenly distributed at the periphery of the hollow cylinder.
